(19) United States
(12) Patent Application Publication
(10) Pub. No.: US 2006/0182040 A1
(43) Pub. Date: Aug. 17, 2006

(54) Device and method for diagnosis in multi-channel-CAN-applications

(75) Inventors: Wolfgang Wiewesiek, Dusseldorf (DE); Masataka Yakashiro, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics (Europe) GMBH

(21) Appl. No.: 11/339,474

(22) Filed: Jan. 26, 2006

Related U.S. Application Data
(63) Continuation of application No. PCT/EP04/08595, filed on Jul. 30, 2004.

(30) Foreign Application Priority Data
Jul. 31, 2003 (DE) 10335075.6

(51) Int. Cl. H04J 1/16

(52) U.S. Cl. 370/252; 370/401

(57) ABSTRACT

A CAN-network comprises several CAN-systems each having a CAN-bus and a CAN-interface which are connected to host-CPU by the CAN-bus. At least one CAN-interface is a selector interface which allows selective access to CAN-busses of other CAN-systems. Thereby it is possible to monitor data exchange on a bus by operating the selector interface in a so-called ‘mirror mode’ in which data of a monitored bus are automatically transferred to the bus of the selector interface. A connection to diagnosis units allows a diagnosis of the data exchange on the monitored bus.

CAN (Controller Area Network according ISO 11898) is a frequently used network in industrial applications and in the automotive field to exchange data between independent nodes. With the recent development in the automotive field the nodes within a vehicle are not connected to a single network anymore. Rather the system design assigns groups of nodes belonging to a certain type of application or that request a certain bus speed to separate CAN-bus systems. However this multi-channel architecture prevents the unobstructed information flow from one network to the other, as it is typically needed for diagnostic purposes.

Currently, the host processor of nodes featuring more than one CAN-interface needs to perform this task with a software algorithm. This requires that the host processor interrupts its regular operation. Then it has to handle the reception of information from one CAN-interface, copy the information to the target CAN-interface, and submit the transit request for these data. This process is very ineffective, as the host processor is typically not using or modifying these data. The delay caused by the processing of the host processor is generally not predictable because high-prioritized tasks can defer the processing for the data transfer. Moreover the data stream that is just passed on to another CAN-interface is heavily influencing the real time behavior of the host processor. Thus, the main object of monitoring data from a CAN-network in an unobstructed way as it is required for the diagnosis is not fulfilled.

There are implementations that relief the host processor from this task. These implementations, called bridges, copy autonomously data from the source CAN-interface to the destination CAN-interface. While the host processor needs not to be interrupted with this architecture, there are still some disadvantages remaining. At first there is still a copy-algo-rithm, which requires a certain time to finish. This time period adds to the propagation delay for the data that shall be transferred. The second disadvantage is that the architecture requires a common memory of all CAN-interfaces of a node for the storage of the CAN-messages. This becomes a major problem when the number of CAN-interfaces per node rises. The more CAN-interfaces there are that work on a common memory, the higher the operating frequency needs to be chosen in order to meet the timing requirements of every CAN-interface at any given point in time.

An apparatus according to the preamble of claim 1 is disclosed in DE-19758032A. This document mentions the use of bridge modules between CAN-interfaces and proposes further to use a common message memory buffer for all CAN-systems of a node, for instance in form of a content addressable memory, in order to facilitate data transfer between CAN-systems. The problems of bridges and a common memory have been mentioned above, and furthermore, content addressable memories are specific for particular applications and have to be accordingly reconstructed when the application is changed. This is forced by the fact that content addressable memories are specifically designed for a particular process technology only.

It is therefore an object of the invention to provide a data network and a method for operating a data network in which messages can be transferred from one CAN-bus system to another CAN-bus system in an easy way and which allows for an easy monitoring of a CAN-system.

This object is achieved by a data network as defined in claim 1 and by a method as defined by claim 6; the dependent claims are related to further developments of the invention.

According to the invention it is proposed to modify the CAN-interface of one of the CAN-systems to a ‘selector-interface’. This selector-interface can selectively be connected to a CAN-bus of another CAN-system in order to monitor data exchange on this bus. To this end the selector interface is equipped with a selector and a protocol handler for the bus to be monitored as well as a further protocol handler for its own bus. This selector interface can be operated in a so-called ‘mirror mode’ in which data of the bus to be monitored are automatically transferred (and mirrored) on the bus of the selector interface. This bus can be advantageously connected with diagnosis units in order to make a diagnosis on the data exchanged on the monitored bus.

The method described here avoids the disadvantages of nowadays CAN-gateways when they need to provide a data stream from a monitored CAN-bus system to another CAN-bus system. The method requires no specific implement of those CAN-interfaces that are connected to a CAN-bus that shall be monitored.

Furthermore, the data transfer is organized such that no copy process of the message is utilized which reduces the propagation delay for mirrored messages and thus enhances the system performance.

In a development of the invention the selector interface can be provided with a filter function so that data transfer is limited to a subset of messages defined in one or more filters that may include masks for defining ranges of filtered messages. With this positive filter function all not defined messages will not be transferred from the monitoring CAN-interface to the CAN-bus.

Furthermore, a negative filter function can be used wherein single messages or ranges of messages are excluded from data transfer from the monitoring CAN-interface to the CAN-bus. This negative filter function defines one or more filters that may include masks for defining ranges of filtered messages. Messages that meet the filter criteria are not copied from the monitoring CAN-interface to the CAN-bus while all other messages that do not have to be known explicitly will be made available on the CAN-bus.

An embodiment of the invention will be described with respect to the appended figures.

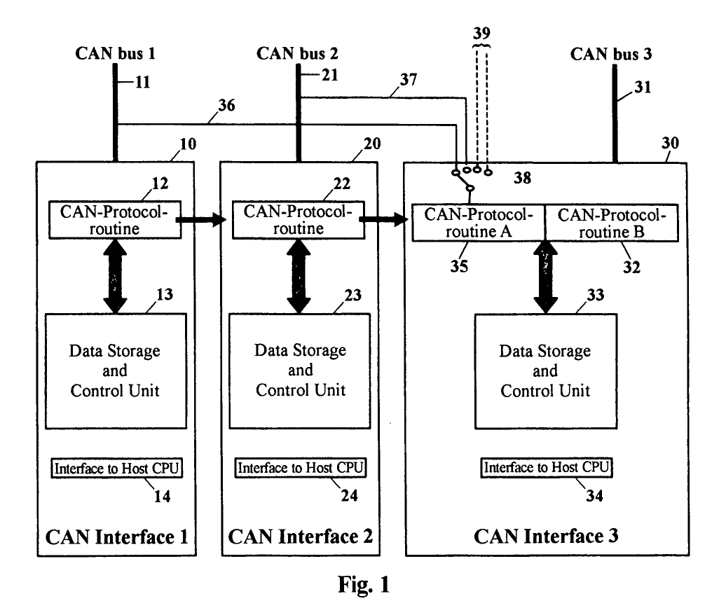

FIG. 1 shows a block diagram of a basic structure of a CAN-gateway with three channels;

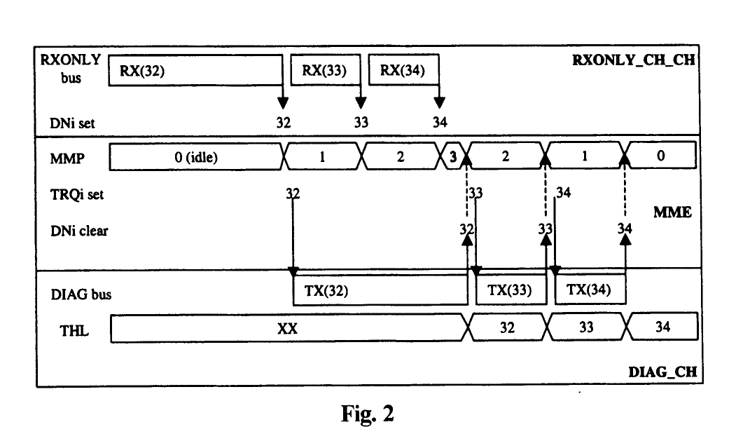

FIG. 2 shows a signal diagram for explaining basic principles of a mirror mode, and

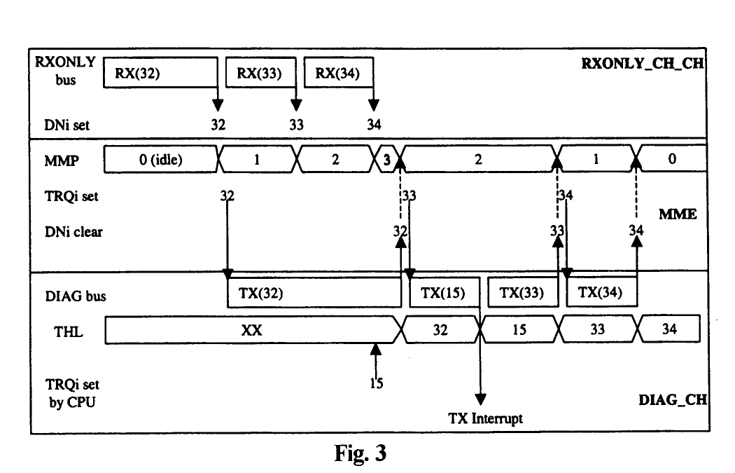

FIG. 3 shows a signal diagram for explaining an interleaved activity.

In the structure of FIG. 1 first and second CAN-interfaces 10, 20 are shown. These CAN-interfaces have identical structures with a dedicated CAN-bus 11, 21, a CAN-protocol handler 12, 22, data storage and control engine 13, 23, and an interface 14, 24 to a host CPU (not shown) which constitutes a node.

The architecture as described so far is well known and comprises usually several of the above mentioned CAN-interfaces with dedicated buses. In order to provide a data stream from CAN-bus 11 or 21 to another CAN-bus or CAN-interface it is necessary to perform a data transfer by the host processor connected to the corresponding interface. Namely the host CPU has to read the data from the data storage of one CAN-interface, copy it into for instance a common message buffer memory and further store it in the data storage of a fur-ther CAN-interface.

On the other hand, the structure described below allows performing this task independently from the host processor. The structure does not even require a specific implementation for each CAN-interface (CAN-I/F). Only one CAN-interface needs to be replaced by a dedicated specific hardware.

The basic concept of the invention is implemented by a third CAN-interface 30 which is a modified version of the CAN-interfaces 10, 20 as already described. Furthermore, additional connections 36, 37 between the buses of the CAN-interfaces to be monitored an additional input terminal at the third CAN-interface 30 are provided.

In order to access to the data stream of CAN-bus 10 or 20, the CAN-interface 30 is equipped with a second CAN-protocol handler 35. This protocol handler is configured such that it can only receive messages. Transmissions of messages of error signaling to the monitored CAN-bus system is suppressed. Via a programmable selector 38 the host processor chooses a source channel that shall be monitored. After the host processor has initialized all parameters necessary for the data transfer to the CAN-bus 30, an operational mode for the diagnosis support called ‘mirror mode’ can be started.

While the mirror mode is active all valid CAN-frames that are exchanged on the monitored bus are received by the CAN-protocol handler 35 in CAN-interface 30. The frames are stored in the message buffer memory 33 that is usually utilized by the regular CAN-protocol handler 32.

Only a portion of the data storage is used by the CAN-protocol handler 35 during the mirror mode. Therefore, the host processor can still receive and transmit regular application messages at the same time through CAN-protocol handler 32.

Once a frame from the monitored CAN-bus is received, a dedicated state machine will launch a transmission request for this frame on CAN-protocol handler 23. The frame participates at the internal priority scheme for transmit messages of CAN-interface 30. If it has the highest priority of all messages with a pending transmit request, it is send on the CAN-bus 31.

The sequence of messages received via CAN-protocol handler 35 is identical to the sequence sent on CAN-protocol handler 32 when no further application messages are sent by the host processor. If the application chooses to send additional messages prepared by the host processor of the node, these messages are interleaved into the data stream on CAN-bus 31 according to the priority rules defined by the CAN-protocol (ISO 11898).

The confinement of the sequence of message from the monitored CAN-bus onto the CAN-bus system 31 is achieved by a certain storage algorithm at message reception. The data storage and control engine 33 stores any received message from CAN-protocol handler 35 in a fixed (i.e. ascending) order within the message buffer memory. Thus the process handling the transmissions on the CAN-bus system 31 knows a priori which message needs to be transmitted next.

A newly received message is prepared for transmission when no other previously received messages from the monitored CAN-bus system are processed by the mirror mode. This can be a message with pending transmission request that is currently transmitted on the CAN-bus system 31 or waiting to win the internal arbitration process. Additionally, it can be one or more messages already received by CAN-protocol handler 35 but that have not set up their transmission request yet.

Once the data storage and control engine 33 recognizes that a transmission was completed on CAN-bus system 31, it checks whether this event belongs to a message invoked by the CPU or if it was invoked by the mirror mode. In the latter case the next message following the storage order of the reception process of CAN-bus handler 35 is prepared for transmission. The process of the mirror mode is shown in FIG. 2.

The invention offers to monitor the data stream of a particular CAN-bus from another CAN-bus connected to the same node. This diagnosis function is executed without any impact to the real time behavior of the host processor. This feature becomes even more important when the diagnosis function shall be used to identify a malfunction of the system. Only the non-intrusive kind of operation of the mirror mode guarantees that a potential malfunction is not suppressed by the activity of the data transfer function itself.

The message transmitted on the CAN-bus 3 is taken directly from the memory location where the message previously received from the monitored CAN-bus system (CAN-bus 1, 2) was stored. This reduces the amount of memory and as a more important item, the transfer process from the monitored CAN-bus system to the CAN-bus 3 is organized faster as if an internal copy process from a receive buffer to a dedicated transmit buffer has to be performed. During the mirror mode operation the message buffer is prepared such that the reception from the monitored CAN-bus system is performed although the message buffer carries all attributes of a transmit buffer. Thus, the following transmit operation on the CAN-bus 3 within the mirror mode can be initiated with a single instruction. Thus, the latency of a ‘mirrored’ message is reduced to the minimum, which is given by the message length (the presence of a message on the CAN-bus) itself. This is an important feature of a diagnosis system.

The CAN-interface equipped with the mirror mode can be added to the design of any CAN-node without changing the already present CAN-interfaces. This modularity opens opportunities to use the mirror mode also in existing products.

Compared to existing solutions that feature CAN-bridges to transfer data from one to another CAN-bus, the mirror mode offers to use a more simple design of the data storage. Nowadays CAN-bridges need a common data storage for all CAN-interfaces that want to participate at the data transfer between different CAN-bus systems. The mirror mode does not require this architecture. The design becomes more complex, and the timing requirements for architectures with common data storage are much more stringent than the architecture shown in FIG. 1. The mirror mode relaxes this part of the design with the result that the CAN-interfaces can be operated at lower frequencies, and each CAN-interface can be designed as a stand alone circuit.

The term ‘mirror mode’ represents that data on one CAN-bus are mirrored to another CAN-bus by a dedicated CAN-interface. Transfer of messages from one CAN-bus system to another CAN-bus system is performed without copying the messages. The received data from the CAN-bus that is monitored is stored in the same location (message buffer) from where it is sent onto the other CAN-bus (i.e. diagnosis CAN-bus).

The mirror mode provides a non-intrusive method to measure or watch the data-stream of a CAN-bus system that is not directly connected to the CAN-bus system where the data shall be made available.

The mirror mode provides exactly the same sequence of valid messages on the diagnosis CAN-bus as the sequence was seen on the monitored CAN-bus system.

The mirror mode handles all valid frame types: data frames and remote frames. Both formats for identifier, standard and extended identifier are processed by the mirror mode.

The mirror mode utilizes two CAN-protocol handlers that work onto a common data storage and control area (message buffer area). The CAN-protocol handler connected to the monitored CAN-bus system shares a part of the message buffer area. Thus the other CAN-protocol handler is able to process messages from the host processor at the same time when the mirror mode is active independently. When the mirror mode is not activated by the host processor, the complete message buffer area is assigned to the CAN-protocol handler for the diagnosis CAN-bus.

The CAN-interface equipped with mirror mode can be integrated into existing multi-chan-nel CAN-nodes without changing the design of the existing CAN-interfaces. The mirror mode is independent with respect to the number of CAN-interfaces used in a node.

FIG. 2 illustrates the timeline of several messages (RX(32), RX(33), RX(34)) received from the monitored CAN-bus system in the top row. The valid reception of these message occurs when DNi (Data New flag for message buffer i) turns 3.

A mirror mode engine (MME) as part of the data storage and control engine 33 processes each reception and increments the counter that reflects the number of already received messages still waiting to be transmitted on the CAN-bus system 31. The transmission request (TRQi) is set for the respective message buffer in the sequence as the received messages were stored. The transmission request is issued anytime MMP equals or anytime a transmission completion on the CAN-bus system 31 is recognized.

The lower horizontal row shows the bus activity of the CAN-bus system 31 (row DIAG) and the transmission completion state named THL (transmission history list).

FIG. 3 shows the operations of the mirror mode when the CPU interleaves other messages.

In the example the CPU submits a transmission request for message object 15 (TX15). This message object is not located in the storage area used for the mirror mode but it still belongs to the data storage and control engine 33. Message object 15 is assumed to have a higher priority than TX(33) and TX(34).

The transmission request by the CPU is now serviced after TX(32). Still the MME prepares message RX(33) for transmission after transmission of TX(32) is completed. After TX(15) was transmitted the MME recognizes that this transmission completion at the end of message TX(15) is not belonging to a mirrored message object. Thus no new transmission request is launched and the MME waits for TX(33) to complete transmission before the transmission for message object RX(34) is requested.

This example demonstrates how a diagnosis for a monitored bus can be issued in parallel with communication that the host CPU requests.

The described architecture is an example only. The mirror mode can be applied to any node that comprises any amount of CAN-channels.

It needs to be pointed out that the number n of CAN-channels (n) on the host processor is absolutely independent for the mirror mode.

For a very specific case n can even equal 1. In that case there exists only the CAN-I/F3 and the connection to the monitored CAN-bus system is not done “on-chip” but routed to another node of the CAN-bus system of the application.

Furthermore, it needs to be pointed out that the host processor does not have to support the operation of the mirror mode once it is initialized and that the host processor is not influenced by the operation of the mirror mode.

Furthermore, in conjunction with the mirror mode positive or negative filter functions can provide an enhanced kind of operation to the customer. The costumer can select to retrieve a subset of messages from the monitored bus 11, 21 on one hand. This feature, a positive identification or positive filter function, can be implemented in the selector interface 30 and can be set or activated by a customer. On the other hand, there exists the opportunity to implement negative filter functions. Negative filters work that way that the user specifies identifiers (=messages in this context) or ranges of identifiers that shall not participate in the mirror mode. With this function the customer can suppress sensible data on the diagnosis bus system. As the diagnosis bus provides a regular access point for instance for garages or police, unauthorized access would have a change to obtain information if not prevented in the mirror mode.

1. Data-network comprising a plurality of CAN-systems, each CAN-system comprising a CAN-bus (11, 21, 31) and a CAN-interface (10, 20, 30) connected to said CAN-bus for exchanging data with a host CPU,
characterized in that the CAN-interface (30) of at least one CAN-system is a selector interface (30) for selectively accessing CAN-buses (11, 21) of other CAN-systems.

2. Data-network according to claim 1, wherein each CAN-interface comprises a CAN-protocol handler (12, 22, 32) for data exchange with its own CAN-bus (11, 21, 31), a data storage and control means (13, 23, 33) and an interface (14, 24, 34) to said host CPU and wherein that selector interface (30) additionally comprises a selector (38) for selecting a CAN-bus of another CAN-system, and a second CAN-protocol handler (35) for data exchange with said selected CAN-bus (11, 21).

3. Data-network according to claim 2, wherein said selector interface (30) comprises monitoring means for monitoring data exchange on a selected CAN-bus and for transmitting identified valid messages from said selected CAN-bus on its own CAN-bus (31).

4. Data-network according to claim 3, wherein said identified valid messages are stored in a location of said storage means (33) of said selector interface (30) and sent to said CAN-bus (31) from said location.

5. Data-network according to claim 4 wherein said CAN-bus (31) of said selector interface (30) is connected to diagnosis units.

6. Method of operating a data network comprising a plurality of CAN-systems, each CAN-system comprising a CAN-bus (11, 21, 31) and a CAN-interface (10, 20, 30) for data exchange with a host CPU, said method comprising the steps of selectively connecting one of said CAN-interfaces (30) with a CAN-bus (11, 21) of a different CAN-system and monitoring data exchange on said CAN-bus (11, 21) via said one CAN-interface (30).

7. Method according to claim 6, wherein said one CAN-interface (30) is set in a mirror mode in which valid messages exchanged on that monitored CAN-bus (11, 21) are automatically sent to the CAN-bus (31) associated with the monitoring CAN-interface (30).

8. Method according to claim 6, wherein said data transfer is organized such that no copy process of the message is utilized.

9. Method according to claim 6, wherein the data transfer is limited to a subset of messages defined in one or more filters that may include masks for defining ranges of filtered messages.

10. Method according to claim 6, wherein single messages or ranges of messages are excluded from the data transfer from the monitoring CAN-interface (30) to the CAN-bus (31) by the use of a negative filter function.

11. Data-network according to one of claims 1 to 5, wherein said selector interface (30) comprises filter means for transmitting only messages or ranges of messages that match certain criteria.

12. Data-network according to one of claims 1 to 5, wherein said selector interface (30) comprises filter means for inhibiting transfer of messages that match certain criteria.
